(19) United States
(12) Patent Application Publication
(10) Pub. No.: US 2026/0082158 A1
(43) Pub. Date: Mar. 19, 2026

(54) VIBRATION APPARATUS

(71) Applicant: LG Display Co., Ltd., Seoul (KR)

(72) Inventor: Jae Won Hwang, Gyeonggi-do (KR)

(21) Appl. No.: 19/096,067

(22) Filed: Mar. 31, 2025

(30) Foreign Application Priority Data
Sep. 19, 2024 (KR) 10-2024-0126668

(51) Int. Cl. H04R 17/10

(52) U.S. Cl. CPC H04R 17/10

(57) ABSTRACT

A vibration apparatus including a vibrating member, and a vibration module including a vibration plate arranged on the vibrating member, and a vibrating element arranged on the vibration plate, wherein the vibration plate includes a protruding part arranged outside a periphery of the vibrating element.

### CROSS-REFERENCE TO RELATED APPLICATION

Pursuant to 35 U.S.C. § 119(a), this application claims the benefit of an earlier filing date and right of priority to Korean Patent Application No. 10-2024-0126668, filed on Sep. 19, 2024, the disclosure of which is incorporated herein by reference in its entirety.

### TECHNICAL FIELD

This specification relates to an apparatus that generates vibrations.

### BACKGROUND

Acoustic apparatuses have a vibration system that converts an electrical input signal into physical vibrations. Piezoelectric loudspeakers made from piezoelectric elements are used in a variety of applications because they have the advantage of being lightweight and low power consumption.

The piezoelectric element requires an enclosure tape to attach a cover of a back surface to the back surface of a panel to form a vibration region. However, there are problems in that the internal volume is determined by the thickness of the enclosure tape, which changes the reproduction frequency band, and it is difficult to dissipate the heat generated by the panel as the thickness of the enclosure tape increases.

In addition, the shape or structure of the cover of the back surface attached to the back surface of the panel determines the internal volume, making it sometimes difficult to freely control the vibration region with the enclosure tape.

In addition, the piezoelectric elements are thin, which increases the likelihood of cracking when attached to the back surface of the panel or during transport.

### SUMMARY

An implementation of the present specification may provide a vibration apparatus in which a vibration region can be adaptively designed.

An implementation of the present specification may provide a vibration apparatus in which a reproduction frequency band can be more easily adjusted.

An implementation of the present specification may provide a vibration apparatus having excellent heat dissipation performance.

An implementation of the present specification may provide a vibration apparatus capable of reducing the occurrence of cracks in a vibrating element.

The problems to be solved in the present specification are not limited to the above-mentioned problems, and other problems not mentioned may be clearly understood by those skilled in the art to which the technical idea of the present specification belongs from the following description.

A vibration apparatus according to one or more implementations of the present specification includes: a vibrating member and at least one vibration module arranged on the vibrating member, and the vibration module includes a vibrating element, and a vibration plate including a pad part on which the vibrating element is arranged, and a protruding part arranged on the pad part outside a periphery of (e.g., surrounding) the vibrating element.

Details of various examples provided in this specification, in addition to those described above, are included in the following description and drawings.

A vibration apparatus according to one or more implementations of the present specification can adaptively implement a vibration region to adjust a reproduction frequency band.

A vibration apparatus according to one or more implementations of the present specification can adjust a reproduction frequency band by adjusting the stiffness of a vibration module.

A vibration apparatus according to one or more implementations of the present specification can effectively dissipate heat generated in a panel by a vibration module.

A vibration apparatus according to one or more implementations of the present specification can improve the problem of cracks occurring in a vibrating element because the vibrating element is transported in a state in which the vibrating element is fixed to a vibration plate.

A vibration apparatus according to one or more implementations of the present specification can have a signal supply member of a vibrating element formed as one component together with a vibration generating part, thereby achieving the effect of a uni-materialization.

The effects of this specification are not limited to the effects mentioned above, and other effects not mentioned will be clearly understood by a person having ordinary skill in the technical field to which the technical idea of this specification belongs from the description below.

### BRIEF DESCRIPTION OF THE DRAWINGS

The above and other objects, features, and advantages of the present specification will become more apparent to those of ordinary skill in the art by describing example implementations thereof in detail with reference to the attached drawings, in which:

FIG. 1 is a perspective view showing an example of a vibration module in a vibration apparatus according to an implementation of the present specification;

FIG. 2 is a cross-sectional view taken along line I-I′ shown in FIG. 1 according to an implementation of the present specification;

FIG. 3 is a view illustrating an example of a state in which a vibration module according to one implementation of the present specification is attached to a panel;

FIG. 4 is a cross-sectional view illustrating an example of a vibration apparatus according to one implementation of the present specification;

FIG. 5 is a modified example of FIG. 4;

FIG. 6 is a plan view showing an example of a vibration module according to one implementation of the present specification;

FIG. 7A is a plan view showing an example of a vibration module according to another implementation of the present specification;

FIG. 7B is a plan view showing an example of a vibration module according to another implementation of the present specification;

FIG. 8 is a plan view showing an example of a vibration module according to another implementation of the present specification;

FIG. 9 is a plan view showing an example of a vibration module according to another implementation of the present specification;

FIG. 10 is a plan view showing an example of a vibration module according to another implementation of the present specification;

FIG. 11 is a cross-sectional view showing an example of a vibration module according to another implementation of the present specification;

FIG. 12 is a cross-sectional view showing an example of a vibration module according to another implementation of the present specification;

FIG. 13 is a modified example of FIG. 12;

FIG. 14 is a view showing an example of a vibration apparatus according to another implementation of the present specification;

FIG. 15 is a cross-sectional view of FIG. 14;

FIG. 16A is a partial enlarged view of FIG. 15;

FIG. 16B is a modified example of FIG. 16A;

FIG. 17 is a view showing an example of a vibrating element according to one implementation of the present specification;

FIG. 18 is a cross-sectional view taken along line II-II′ shown in FIG. 17 according to one implementation of the present specification;

FIG. 19 is a cross-sectional view taken along line III-III′ shown in FIG. 17 according to one implementation of the present specification;

FIG. 20 is a view showing an example of a vibration module according to one implementation of the present specification;

FIG. 21 is a cross-sectional view of FIG. 20;

FIG. 22 is a view showing an example of a vibration module according to another implementation of the present specification; and

FIG. 23 is a cross-sectional view of FIG. 22.

### DETAILED DESCRIPTION

The advantages and features of the present specification, and methods of achieving them will be apparent from the implementations described in detail below in conjunction with the accompanying drawings. However, the present specification is not limited to the following implementations disclosed herein, but may be implemented in various different forms; rather, the present implementations are provided to make the disclosure of the present specification complete and to enable those skilled in the art to fully comprehend the scope of the present specification.

The shapes, sizes, proportions, angles, numbers, and the like of elements shown in the drawings to illustrate implementations of the present specification are merely illustrative and are not intended to be limiting. Identical reference numerals may designate identical components throughout the description. Further, in describing the present specification, detailed descriptions of related known technologies may be omitted so as not to obscure the essence of the present specification. Terms such as “comprising,” “including,” “having,” or “consisting of” as used herein are generally intended to allow for the addition of other components, unless the terms are used with the term “only.” References to components of a singular noun include the plural of that noun, unless specifically stated otherwise.

In the interpretation of components, they are construed to include margins of error, even if this is not explicitly stated.

When describing a positional relationship, for example, “on top of,” “above,” “below,” or “next to” describes the positional relationship of two parts, one or more other parts may be located between the two parts, unless “immediately”or “directly”is used.

When describing a temporal relationship, “after,” “following,” “next to,” or “before” describes a temporal antecedent or consequent relationship, which may not be continuous unless “immediately”or “directly”is used.

The first, the second, and so on are used to describe various components, but these components are not limited by these terms. These terms are used only to distinguish one component from another. Therefore, the first component referred to below may be a second component within the technical spirit of the present specification.

Terms such as first, second, A, B, (a), or (b) may be used to describe elements of the implementations of the present specification. Such terms are intended only to distinguish one component from another and are not intended to define the nature, sequence, order, or number of such components. When a component is described as “connected,” “coupled,” or “attached” to another component, it is to be understood that the component may be directly connected or attached to the other component, but that there may also be other components “interposed” between the respective components which may be indirectly connected or attached where not specifically stated.

It should be understood that the term “at least one” includes all possible combinations of one or more related components. For example, the meaning of “at least one of the first, second, and third components” can be understood to include not only the first, second, or third component, but also any combination of two or more of the first, second, and third components.

Each of the features of various implementations described herein may be coupled or combined with one another in whole or in part, and may be technologically interlocked and operated in various ways, and each of the implementations may be carried out independently or in conjunction with one another.

Hereinafter, implementations of the present specification are illustrated by way of the accompanying drawings and examples. The scale of the components depicted in the drawings is different from the actual scale for convenience of explanation, and is not limited to the scale depicted in the drawings.

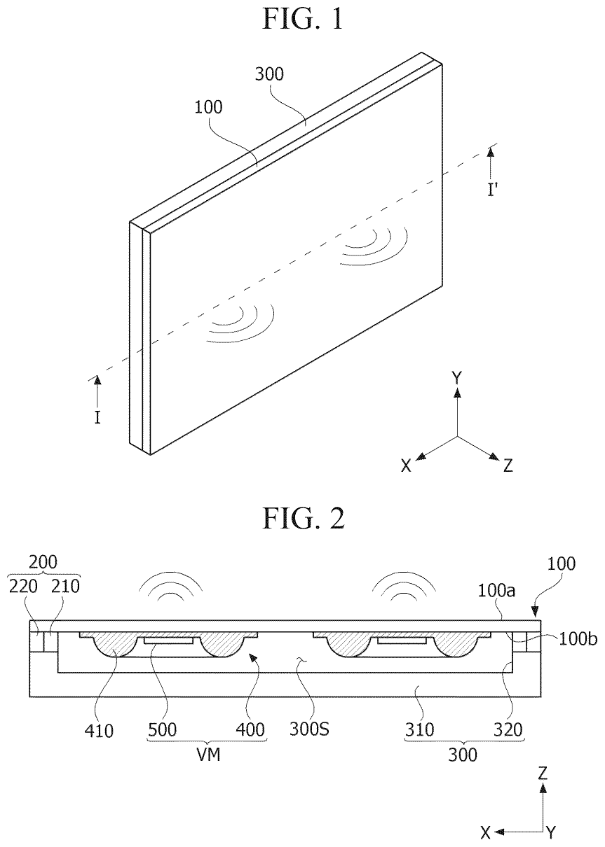

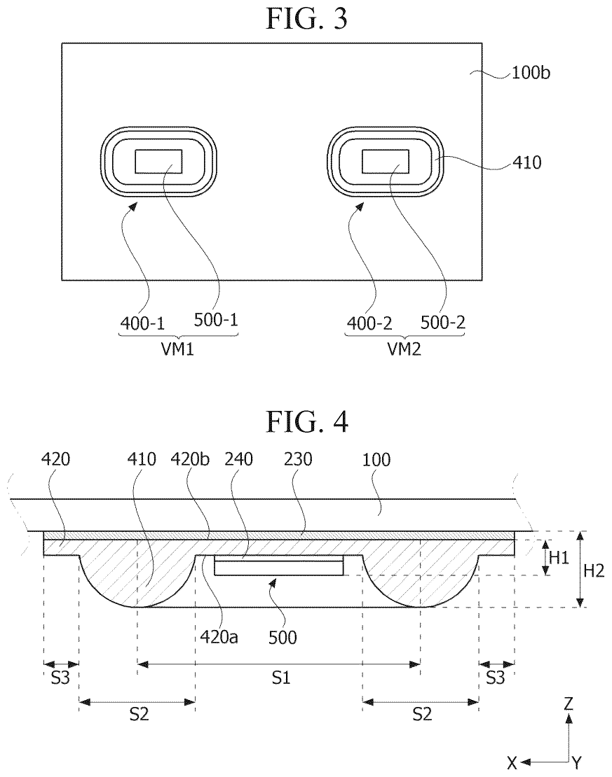

FIG. 1 is a perspective view showing an example of a vibration module in a vibration apparatus according to an implementation of the present specification. FIG. 2 is a cross-sectional view taken along line I-I′ shown in FIG. 1 according to an implementation of the present specification. FIG. 3 is a drawing showing a state in which a vibration module is attached according to one implementation of the present specification.

Referring to FIGS. 1 to 3, the vibration apparatus according to an implementation of the present specification may include a vibrating member 100 and a vibration module (VM) attached to the vibrating member 100.

The vibrating member 100 may be any of various types of vibrating members, other than a display panel (e.g., other than a liquid crystal panel or an organic light-emitting device panel). For example, the vibration apparatus may be implemented as an acoustic apparatus, a sound bar, an acoustic system, an acoustic apparatus for electronic equipment, an acoustic apparatus for a display, an acoustic device for a transport apparatus, or a sound bar for a transport apparatus.

The vibrating member 100 may generate vibrations or output sounds (or sound waves) in accordance with the displacement (or driving) of the vibrating element 500. The vibrating member 100 may include a polygonal shape including a rectangular shape or a square shape, but the implementations of the present specification are not limited thereto. The vibrating member 100 may include a horizontal length parallel to the first direction X and a vertical length parallel to the second direction Y. For example, with respect to the same plane, the first direction X may be a first horizontal direction or a first horizontal longitudinal direction of the vibrating member 100, and the second direction Y may be a second horizontal direction or a second horizontal longitudinal direction of the vibrating member 100 orthogonal to the first direction X.

The vibrating member 100 may include a structure having a consistent thickness as a whole, but the implementations of the present specification are not limited thereto. For example, the vibrating member 100 may include a flat structure having a consistent thickness as a whole, but implementations of the present specification are not limited thereto. For example, the vibrating member 100 may include a non-planar structure, e.g., having convex and/or concave portions.

According to one implementation of the present specification, the vibrating member 100 may include a first surface 100a and a second surface 100b. The first surface 100a of the vibrating member 100 may be a front surface, a forward surface, an upper surface, or a surface of the upper portion. The second surface 100b of the vibrating member 100 may be a back surface, a backward surface, a rear surface, a surface of the back portion, a lower surface, or a surface of the lower portion.

The vibration module VM may include a vibration plate 400 attached to the vibrating member 100 and a vibrating element 500 attached to the vibration plate 400 to apply vibration to the vibrating member 100. The vibration module VM may be located at the back surface of the vibrating member 100, but implementations of the present specification are not limited thereto. For example, the vibration module VM may be located on a side surface or corner portion or other region of the vibrating member 100.

In some implementations, the vibration module VM may be one of multiple vibration modules, such as a first vibration module VM1 and a second vibration module VM2, arranged in a vibrating member 100 as shown in the example of FIGS. 2 and 3. The first vibration module VM1 may include a first vibration plate 400-1 and a first vibrating element 500-1, and the second vibration module VM2 may include a second vibration plate 400-2 and a second vibrating element 500-2. However, the implementations of the present specification are not limited thereto. For example, a plurality of vibration modules VM may be arranged, such as four, six, or eight, or only one vibration module VM may be arranged on the vibration member 100.

The vibration plate 400 may have a polygonal shape including a square shape, a hexagonal shape, an octagonal shape, a circular shape, or an elliptical shape, but the shape of the vibration plate 400 is not particularly limited. The corners of the vibrating plate 400 may have a round shape, as shown in the example of FIG. 3, but the implementations of the present specification are not limited thereto.

The vibration plate 400 may be made of one or more of various materials such as plastic, resin, and metal. A reproduction frequency band of the vibration plate 400 may be adjusted depending on the material of the vibrating plate 400. For example, if the strength of material(s) in the vibrating plate 400 is low, the reproduction frequency band may be lowered. Conversely, if the strength of material(s) in the vibrating plate 400 is high, the reproduction frequency band may be increased. The reproduction frequency band may be a frequency band of a sound generated by the vibration of the vibrating member.

The vibration plate 400 may include a protruding part 410 arranged outside a periphery of the vibrating element 500. For example, the protruding part 410 may be arranged to completely surround the vibrating element 500, or may be arranged around only a portion of the vibrating element 500. As such, a vibration region can be adjusted according to the area by which the protruding part 410 is arranged outside the periphery of the vibrating element 500, and accordingly, the reproduction frequency band may be changed. The vibration plate 400 may be a dome structure, a vibration pad, a pad part, or a vibration control plate, but the implementations of the present specification are not limited thereto.

When the area by which the protruding part 410 is arranged outside the periphery of the vibrating element 500 increases, the vibration region may be widened to lower the reproduction frequency band, and when the area by which the protruding part 410 is arranged outside the periphery of the vibrating element 500 decreases, the vibration region may be narrowed to increase the reproduction frequency band.

The cross section of the protruding part 410 may have a semicircular or semi-elliptical shape such as a dome, as shown in FIG. 2, but the implementations of the present specification are not limited thereto. For example, the cross-section of the protruding part 410 may have a polygonal shape such as a triangular shape, a trapezoidal shape, or a square shape. A curvature may be formed at each corner of a polygonal shape. The height of the protruding part 410 may be constant along the extension direction, but the implementations of the present specification are not limited thereto. For example, the height of the protruding part 410 may be configured differently along the extension direction.

The vibrating element 500 may be arranged on the vibrating plate 400 to vibrate the vibrating member 100. The vibrating element 500 may be configured to vibrate (or displace or drive) the vibrating member 100 by vibrating (or driving) according to an applied drive signal (or an electric signal or a voice signal). For example, the vibrating element 500 may be an active vibrating member, a vibration generator, a vibration structure, a vibrator, a vibration generating element, an acoustic generator, an acoustic element, an acoustic generating structure, or an acoustic generating element, but the implementations of the present specification are not limited thereto.

As an example, the vibrating element 500 according to implementations of the present specification may include a piezoelectric material or an electro-active material having the piezoelectric properties. The vibrating element 500 may vibrate (or displace) itself or vibrate (or displace) the vibrating member 100 or the like according to the vibration (or displacement) of the piezoelectric material according to a driving signal applied to the piezoelectric material. The vibrating element 500 may vibrate (or displace or drive) by alternately repeating contraction and/or expansion through the piezoelectric effects (or piezoelectric properties). For example, the vibrating element 500 may vibrate (or displace or drive) in the vertical direction (or thickness direction) Z by alternately repeating contraction and/or expansion by the piezoelectric effect.

The vibrating element 500 according to one implementation of the present specification may include a rectangular shape having a first length parallel to a first direction X and a second length parallel to a second direction Y. For example, the vibrating element 500 may include a square shape with the first length and the second length equal to each other, but the implementations of the present specification are not limited thereto.

The vibration apparatus according to an implementation of the present specification may include a support member 300.

The support member 300 may be arranged on the back surface of the vibrating member 100. For example, as shown in FIG. 2, the support member 300 may be arranged on the second surface 100b of the vibrating member 100. In some implementations, the support member 300 may be configured to support an edge portion of the second surface 100b of the vibrating member 100.

The support member 300 according to one implementation of the present specification may include an inner space 300S surrounding the second surface 100b of the vibrating member 100. For example, the support member 300 may include a box shape in which one side (or upper side) of the inner space 300S is opened. For example, the support member 300 may be a case, an outer case, a case member, a housing, a housing member, a cabinet, an enclosure, a sealing member, a sealing cap, a sealing box, or a sound box, but the implementations of the present specification are not limited thereto. For example, the inner space 300S of the support member 300 may be an accommodated space, a storage space, a gap space, an air space, a vibration space, an acoustic space, an echo chamber, or a sealed space, but the implementations of the present specification are not limited thereto.

The support member 300 according to one implementation of the present specification may include one or more materials of a metallic material or a non-metallic material (or a composite non-metallic material), but the implementations of the present specification are not limited thereto. For example, the support member 300 may include one or more materials of metal, plastic, and wood, but the implementations of the present specification are not limited thereto.

The support member 300 according to one implementation of the present specification may include a first support part 310 and a second support part 320.

The first support part 310 may be arranged in parallel with the vibrating member 100. The first support part 310 may be arranged to face the second surface 100b of the vibrating member 100. The first support part 310 may be arranged to cover the vibrating element 500 and the second surface 100b of the vibrating member 100. The first support part 310 may be spaced apart from the vibrating element 500 and the second surface 100b of the vibrating member 100. For example, as shown in the example of FIG. 2, the first support part 310 may be spaced apart from the second surface 100b of the vibrating member 100 with an inner space 300S interposed therebetween. The protruding part 410 is arranged to face the first support part 310 of the support member, and the protruding part 410 may be arranged to be spaced apart from the first support part 310.

For example, the first support part 310 may be a floor member, a floor plate, a support plate, a housing plate, or a housing bottom part, but the implementations of the present specification are not limited thereto.

The second support part 320 may be configured or arranged at an edge portion of the vibrating member 100. The second support part 320 may be connected to the edge portion of the first support part 310. For example, the second support part 320 may include a structure bent from the edge portion of the first support part 310. For example, the second support part 320 may be parallel to the third direction Z or sloped from the third direction Z. For example, the support member 300 may include at least two second support parts 320. For example, the second support part 320 may be a side portion, a side wall, a support side wall, a housing side surface, or a housing side wall, but the implementations of the present specification are not limited thereto.

The second support part 320 may be integrated with the first support part 310. For example, the first support part 310 and the second support part 320 may be integrated into one body, and thus the inner space 300S surrounded by the second support part 320 may be provided on the first support part 310. Accordingly, the support member 300 may include a box shape in which one side (or upper side) is opened by the first support part 310 and the second support part 320.

The support member 300 may be connected or coupled to the vibrating member 100. For example, as shown in FIG. 2, the support member 300 may be connected or coupled to the second surface 100b of the vibrating member 100 via a coupling member 200. For example, the support member 300 may be connected or coupled to an edge portion of the second surface 100b of the vibrating member 100 via the coupling member 200.

The coupling member 200 may be configured to minimize or prevent the vibration of the vibrating member 100 from being transmitted to the supporting member 300. The coupling member 200 may have the material properties suitable for blocking vibration. For example, the coupling member 200 may include a material having elasticity. For example, the coupling member 200 may include a material having elasticity for vibration absorption (or shock absorption). The coupling member 200 according to one implementation of the present specification may be formed of a polyurethane material or a polyolefin material, but the implementations of the present specification are not limited thereto. For example, the coupling member 200 may include at least on of an adhesive, a double-sided adhesive, a double-sided tape, a double-sided foam tape, a double-sided foam pad, a double-sided cushion tape, and an enclosure tape, but the implementations of the present specification are not limited thereto.

The coupling member 200 according to one implementation of the present specification prevents physical contact (or friction) between the vibrating member 100 and the second support part 320 of the supporting member 300, thereby preventing the occurrence of sound (or noise) due to physical contact (or friction) between the vibrating member 100 and the supporting member 300. For example, the coupling member 200 may be a buffer member, an elastic member, a damping member, a vibration absorbing member, a vibration preventing member, or a vibration blocking member, but the implementations of the present specification are not limited thereto.

The coupling member 200 according to another implementation of the present specification may be configured to minimize or prevent the vibration of the vibrating member 100 from being transmitted to the supporting member 300, and to reduce the reflection of sound waves generated and incident due to vibration of the vibrating member 100.

The coupling member 200 according to another implementation of the present specification may include a first coupling member 210 and a second coupling member 220.

The first coupling member 210 may be arranged between the vibrating member 100 and the supporting member 300. The first coupling member 210 may be arranged between the vibrating member 100 and the second support part 320. The first coupling member 210 may be arranged or coupled between the edge portion of the back surface of the vibrating member 100 and the second support part 320 of the support member 300. For example, the first coupling member 210 may be arranged inside (or on the inner side) of the second coupling member 220. The first coupling member 210 may be configured to have a lower hardness than the second coupling member 220, such as a smaller modulus or a smaller Young's modulus. For example, the first coupling member 210 may include a double-sided polyurethane tape, a double-sided polyurethane foam tape, or a double-sided sponge tape, but the implementations of the present specification are not limited thereto.

The second coupling member 220 may be arranged between the vibrating member 100 and the supporting member 300. For example, the second coupling member 220 may be arranged between the vibrating member 100 and the support member 300 to surround the first coupling member 210. The second coupling member 220 may be arranged or coupled between the edge portion of the back surface of the vibrating member 100 and the second support part 320 of the supporting member 300.

The second coupling member 220 may be configured to have a greater hardness than the first coupling member 210, such as a larger modulus or a larger Young's modulus. For example, the second coupling member 220 may include a double-sided polyolefin tape, a double-sided polyolefin foam tape, a double-sided acrylic tape, or a double-sided acrylic foam tape, but the implementations of the present specification are not limited thereto.

The coupling member 200 according to implementations of the present specification may absorb sound waves generated and incident due to the vibration of the vibrating member 100 by a relatively soft first coupling member 210 arranged within a relatively hard second coupling member 220, and may minimize the reflected sound (or reflected wave) generated by the coupling member 200. For example, each of the highest and lowest sound pressures generated in the reproduction frequency band of the sound generated by the vibration of the vibrating member 100 may be reduced, thereby reducing the flatness of the sound pressure. For example, the flatness of the sound pressure may be the magnitude of the deviation between the highest sound pressure and the lowest sound pressure.

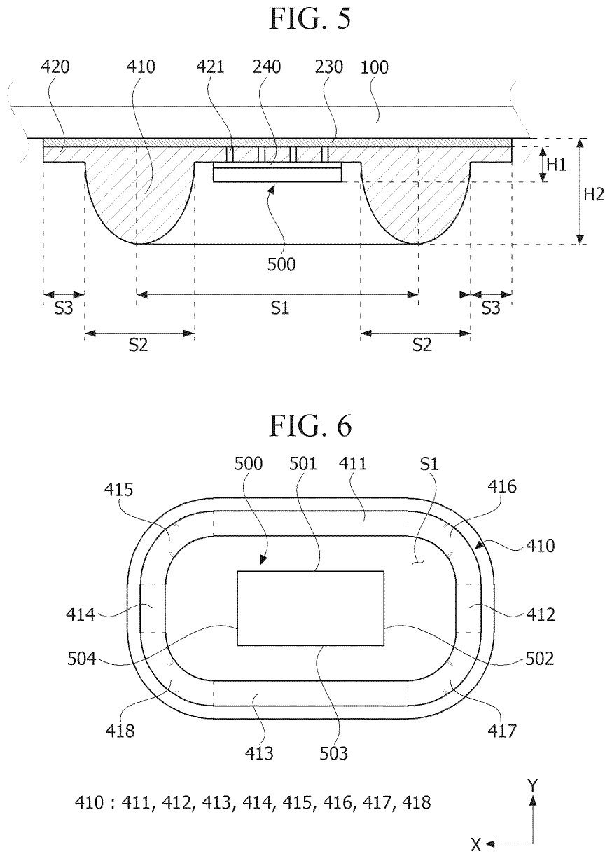

FIG. 4 is a cross-sectional view illustrating an example of a vibration module according to one implementation of the present specification. FIG. 5 is a modified example of FIG. 4.

Referring to FIG. 4, the vibration plate 400 may include a pad part 420 attached to the vibrating member 100 and a protruding part 410 protruding from the pad part 420. In some implementations, the vibration plate 400 may be made of a metallic material such as steel use stainless (SUS), aluminum (Al), copper (Cu), or silver (Ag). When the vibration plate 400 is made of a metallic material, the heat generated by the vibrating member 100 may be effectively dissipated. However, the implementations of the present specification are not limited thereto. For example, the vibration plate 400 may be made of a plastic or wood material in addition or as an alternative to a metallic material.

According to an implementation, the vibration plate 400 may be manufactured entirely from the same material, but is not limited thereto and may be manufactured from different materials, e.g., depending on the region. For example, the pad part 420 of the vibration plate 400 may be made of a metallic material to facilitate heat dissipation of the vibrating member 100, and the protruding part 410 may be made of a plastic material to facilitate workability. If the protruding part 410 is made of a plastic material, it has a relatively low strength and may improve the flatness of the sound pressure by absorbing some of the reflected waves.

According to the implementation, after the pad part 420 of the vibration plate 400 may be manufactured from metal, the protruding part 410 made of plastic material may be formed on the pad part 420 through injection molding. Alternatively, after the fastening part is formed on the pad part 420 made of a metallic material, the protruding part 410 made of a plastic material may be inserted into the fastening part of the pad part 420 to be coupled.

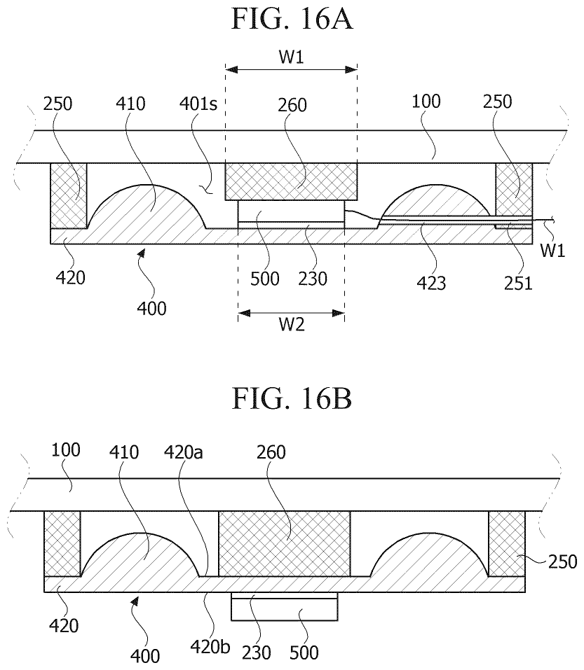

The pad part 420 may include a second surface 420b opposite to the first surface 420a on which the vibrating element 500 is arranged. According to an implementation, the second surface 420b of the pad part 420 may be fixed to the vibrating member 100 by the first connecting member 230. However, the implementations of the present specification are not limited thereto. For example, the first surface 420a of the pad part 420 may be fixed to the vibrating member 100 (as shown in FIGS. 15-16B).

The vibrating element 500 may be fixed to the first surface 420a of the pad part 420 by the second connecting member 240. The first connecting member 230 and the second connecting member 240 may include the same material, but the implementations of the present specification are not limited thereto. For example, the first connecting member 230 and the second connecting member 240 may include different materials.

The first connecting member 230 and the second connecting member 240 according to the implementation of the present specification may include an adhesive layer having excellent adhesion or adhesive force. For example, the first connecting member 230 and the second connecting member 240 may include a foam pad, a double-sided tape, a double-sided foam pad, a double-sided foam tape, an adhesive, a double-sided adhesive, a double-sided adhesive tape, a double-sided adhesive foam pad, or an adhesive sheet, and the implementations of the present specification are not limited thereto.

The vibration plate 400 may include a vibration region S1 formed on the inner side of the protruding part 410. As the area inside the protruding part 410 increases, the vibration region S1 widens and thus the reproduction frequency band may decrease. Conversely, as the area of the vibration region S1 decreases, the reproduction frequency band may increase.

According to an implementation, the vibration region S1 may be freely adjusted by adjusting an area in which the protruding part 410 is arranged outside the periphery of the vibrating element 500. In some scenarios, if the vibration region is adjusted with an enclosure tape and a cover of the back surface, there is a problem in that it is difficult to freely adjust the vibration region because the vibration region is determined by the shape of the cover of the back surface.

In some implementations, the vibration plate 400 includes an outer side portion S3 may be a region protruding outwardly from the protruding part 410. In some implementations, the area of the vibration region S1 may be wider than an area S2 of the protruding part 410 and an area of the outer side portion S3. The area S2 of the protruding part 410 may be smaller than the area of the vibration region S1 and larger than the area of the outer side portion S3. However, the implementations of the present specification are not limited thereto. For example, the area of the vibration region S1 may be equal to or smaller than the area S2 of the protruding part 410. For example, the area of the outer side portion S3 may be equal to or larger than the area of the vibration region S1 and the area S2 of the protruding part 410.

When the outer side portion S3 is widened, an area in which the vibrating plate 400 is fixed to the vibrating member 100 may increase. However, the implementations of the present specification are not limited thereto. When the area to be fixed to the vibrating member 100 is sufficient only by the inner region of the protruding part 410, the outer side portion S3 may be omitted.

According to an implementation, the rigidity of the vibrating plate 400 may be adjusted by adjusting the width and/or height of the protruding part 410. As shown in the example of FIG. 4, the width of the protruding part 410 is the distance in the first direction (X direction) and the height of the protruding part 410 is a distance in the third direction (Z direction). As the width and/or height of the protruding part 410 increases, the rigidity of the vibrating plate 400 may increase. As the rigidity of the vibrating plate 400 increases, the reproduction frequency band may increase.

Conversely, as the width and/or height of the protruding part 410 decreases, the rigidity of the vibrating plate 400 may decrease. As the rigidity of the vibration plate 400 decreases, the reproduction frequency band of the vibration transmitted to the vibrating member 100 may decrease.

As the height H2 of the protruding part 410 increases, the volume of the vibration region S1 may increase. For example, when the height H2 of the protruding part 410 increases further as shown in FIG. 5, the volume of the vibration region S1 may become larger than the vibration region S1 of FIG. 4. Therefore, the vibration region S1 becomes larger, so the sound pressure characteristics may change.

The protruding part 410 may protrude further than the vibrating element 500 in a direction opposite to the vibrating member 100. For example, the height H2 of the protruding part 410 may be greater than the height H1 which includes the thickness of the pad part 420 and the thickness of the vibrating element 500. Therefore, the volume of the vibration region S1 may increase. However, the implementations of the present specification are not limited thereto. For example, in some implementations, the vibrating element 500 may protrude further than the protruding part 410 in the direction opposite to the vibrating member 100.

According to an implementation, there is an advantage in that the degree of freedom in designing the frequency characteristics of the vibrating plate 400 may be increased by adjusting the area of the vibration region S1, the material of the vibration plate 400, and/or the width and/or height of the protruding part 410. Therefore, it is possible to manufacture an optimized vibration module VM according to the specifications of the applicable product.

Referring to FIG. 5, a plurality of through holes 421 may be arranged in the pad part 420 in which the vibrating element 500 is arranged. According to such a configuration, the vibration of the vibrating element 500 may be transmitted more effectively to the vibrating member 100, so that the sound pressure characteristics may be improved.

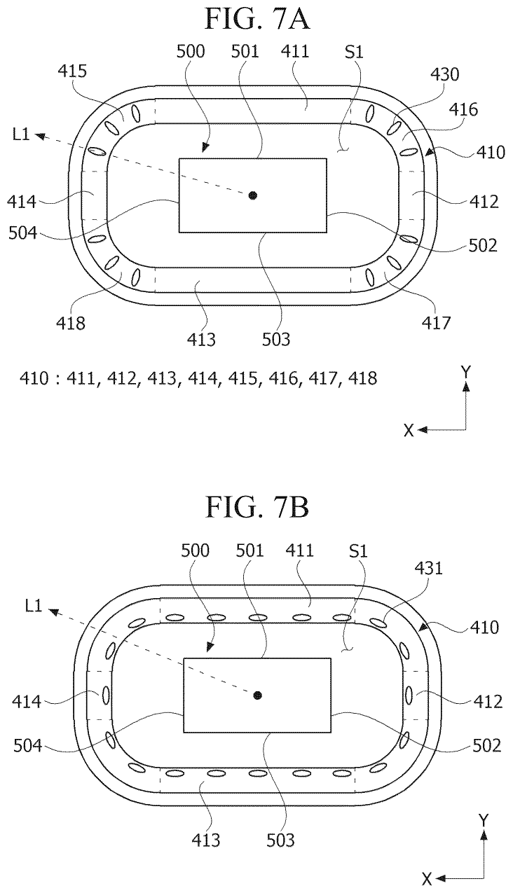

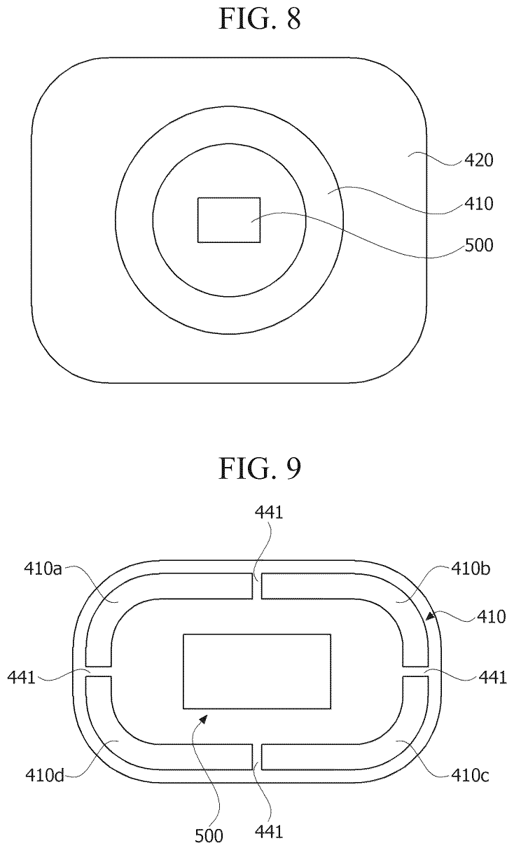

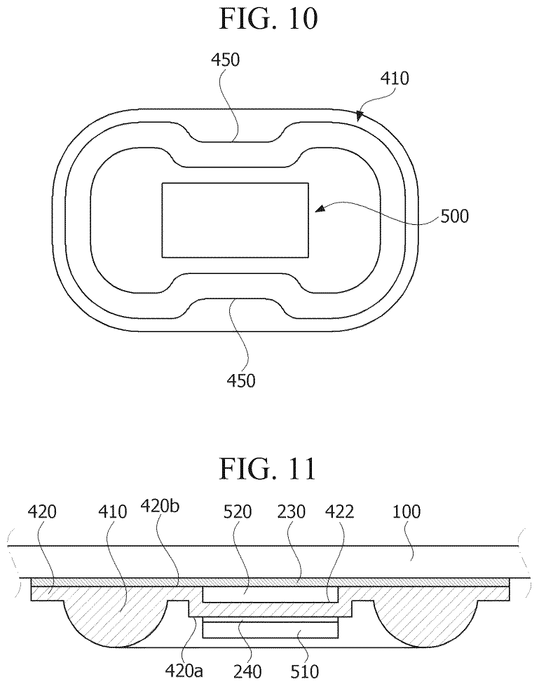

FIG. 6 is a plan view showing a vibration module according to one implementation of the present specification. FIG. 7A is a plan view showing a vibration module according to another implementation of the present specification. FIG. 7B is a plan view showing a vibration module according to another implementation of the present specification. FIG. 8 is a plan view showing a vibration module according to another implementation of the present specification. FIG. 9 is a plan view showing a vibration module according to another implementation of the present specification. FIG. 10 is a plan view showing a vibration module according to another implementation of the present specification. FIGS. 7A and 7B are views showing a configuration in which grooves are arranged in a vibration module according to one implementation of the present specification. FIG. 8 is a view showing a configuration in which the protruding part is circular. FIGS. 9 and 10 are views showing various shapes of protruding parts.

Referring to FIG. 6, the protruding part 410 may include a first protrusion line 411 facing a first side surface 501 of the vibrating element 500, a second protrusion line 412 facing a second side surface 502 of the vibrating element, a third protrusion line 413 facing a third side surface 503 of the vibrating element, and a fourth protrusion line 414 facing a fourth side surface 504 of the vibrating element. The first to fourth protrusion lines 411, 412, 413, and 414 may be straight lines extending in the first direction or the second direction.

The protruding part 410 may include a first connecting line 415 connecting the first protrusion line 411 and the fourth protrusion line 414, a second connecting line 416 connecting the first protrusion line 411 and the second protrusion line 412, a third connecting line 417 connecting the second protrusion line 412 and the third protrusion line 413, and a fourth connecting line 418 connecting the third protrusion line 413 and the fourth protrusion line 414. In this case, the first to fourth connecting lines 415, 416, 417, and 418 may have a curvature. Accordingly, since the protruding part 410 has a curvature at the corner portion, the rigidity is increased, which may prevent the protruding part 410 from being damaged by vibrations.

However, the implementations of the present specification are not limited thereto. For example, the first to fourth protrusion lines 411, 412, 413, and 414) may also have a predetermined curvature. In this case, the protruding part 410 may have an elliptical or circular shape as a whole (see FIG. 8).

Referring to FIG. 7A, a plurality of grooves 430 may be formed on the protruding part 410. The rigidity of the protruding part 410 may be adjusted by forming grooves 430. The groove 430 may have a comb-like shape extending in a direction L1 radiating from the center of the vibrating element 500. However, the implementations of the present specification are not limited thereto. The groove 430 may have a circular shape, an elliptical shape, a line shape or polygonal shape. The length of the groove 430 may also be varied.

The groove 430 is exemplified as being arranged on the first to fourth connecting lines 415, 416, 417, and 418, but is not necessarily limited thereto. The groove 430 may be formed only on some of the first to fourth connecting lines 415, 416, 417, and 418. The groove 430 may be formed on the first to fourth protrusion lines 411, 412, 413, and 414.

Referring to FIG. 7B, the groove 430 may have an extension direction that intersects a direction L1 radiated from the center of the vibrating element 500. For example, a plurality of grooves 430 may be arranged to be spaced apart from each other along the extension direction of the protruding part 410. The lengths of the grooves 430 may all be the same or may be different from each other. Referring to FIG. 8, the protruding part 410 may have a circular shape.

Referring to FIG. 9, the protruding part 410 may include a plurality of sub-protruding parts 410a, 410b, 410c, and 410d, which are spaced apart from each other. A spaced region 441 may be formed between the sub-protruding parts 410. Accordingly, the rigidity of the vibration plate 400 may be adjusted. The spaced region 441 may also serve as an air passage. Therefore, when the vibration region is sealed, the air flow is smooth by connecting or communicating with the outside through the spaced region 441, thereby improving the acoustic characteristics.

Referring to FIG. 10, the protruding part 410 may include a bent part 450 bent toward the vibrating element 500. However, the implementations of the present specification are not limited thereto, and the bent part (450) may be bent in a direction away from the vibrating element 500. Additionally, the number of bent part 450 is not particularly limited.

The bend part 450 may be formed on one or more side surfaces to which the strongest sound wave arrives among the side surfaces of the protruding part 410. According to such a configuration, it is possible to reduce the sound pressure reduction phenomenon.

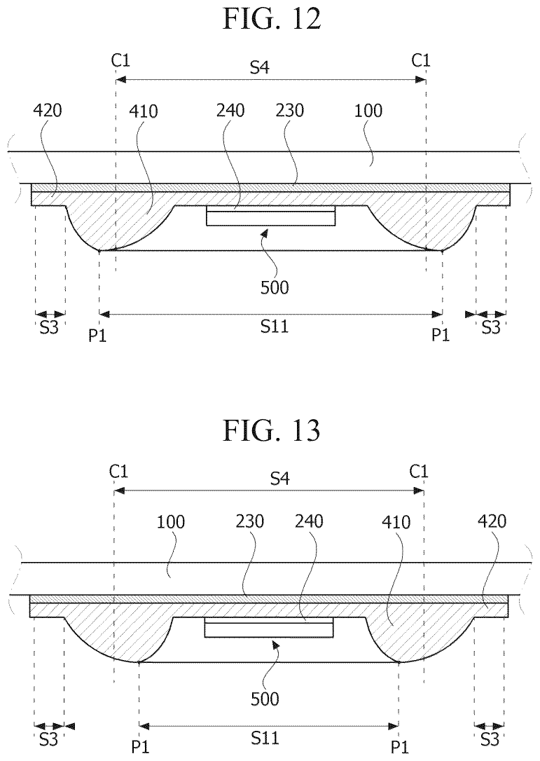

FIG. 11 is a cross-sectional view showing a vibration module according to another implementation of the present specification. FIG. 12 is a cross-sectional view showing a vibration module according to another implementation of the present specification. FIG. 13 is a cross-sectional view showing a vibration module according to another implementation of the present specification. FIGS. 12 and 13 are views showing a state in which the vibration region is adjusted by varying a curved point of the protruding part.

Referring to FIG. 11, the pad part 420 may have an accommodating part 422 formed in the vibration region S1 in which the vibrating element 500 is mounted. A first vibrating element 510 may be arranged on the first surface 420a of the pad part 420, and a second vibrating element 520 may be arranged on the second surface 420b. According to such a configuration, the vibrations of the first vibrating element 510 and the second vibrating element 520 are superimposed and transmitted to the vibrating member 100, so that the sound pressure characteristics may be improved.

For example, the first vibrating element 510 and the second vibrating element 520 may have different sound pressure characteristics. For example, the first vibrating element 510 may have a sound pressure characteristic with an excellent high frequency band, and the second vibrating element 520 may have a sound pressure characteristic with an excellent low frequency band. Therefore, the sound pressure in the low and middle/high sound bands may be improved by the synthesized vibration of the first vibrating element 510 and the second vibrating element 520.

The sizes of the first vibrating element 510 and the second vibrating element 520 may be the same, but may also be different. As described above, the area and thickness structures of the first vibrating element 510 and the second vibrating element 520 may be different from each other in order to have different sound pressure characteristics.

The second vibrating element 520 may be directly attached to the first connecting member 230 to transmit vibration to the vibrating member 100, while the first vibrating element 510 may be arranged on the first surface 420a of the pad part 420 to transmit vibration to the vibrating member 100 through the vibration plate 400.

The height of the protruding part 410 may be designed taking into account that the first vibrating element 510 and the second vibrating element 520 are stacked. Accordingly, the protruding part 410 may protrude further away from the vibrating member 100 than the vibrating element 500.

Referring to FIG. 12, the curved point P1 of the protruding part 410 may be located on an outer side of the center C1 of the protruding part 410. The center C1 of the protruding part 410 may be the center of the width of the protruding part 410. The curved point P1 may be a point at which the height gradually increases and then decreases, or a point at which the height gradually decreases and then increases. The curved point P1 may be a peak point having the maximum height of the protruding part 410.

Since the curved point P1 of the protruding part 410 is located further outward than the center C1 of the protruding part 410, the vibration region (S11>S4) may become larger. Therefore, the reproduction frequency band may be lowered and the sound pressure characteristic may be changed. A slope of an inner side surface of the protruding part 410 may be gentler than that of an outer side surface. The inner side surface or the outer side surface of the protruding part 410 may include a straight section.

On the contrary, if the curved point P1 of the protruding part 410 is located inwardly of the center C1, as shown in FIG. 13, the vibration region may be reduced, which may change the sound pressure characteristic. A slope of the outer side surface of the protruding part 410 may be gentler than the slope of the inner side surface. According to an implementation, the vibration region may be changed by adjusting the curved point of the protruding part, thereby freely adjusting the reproduction frequency band.

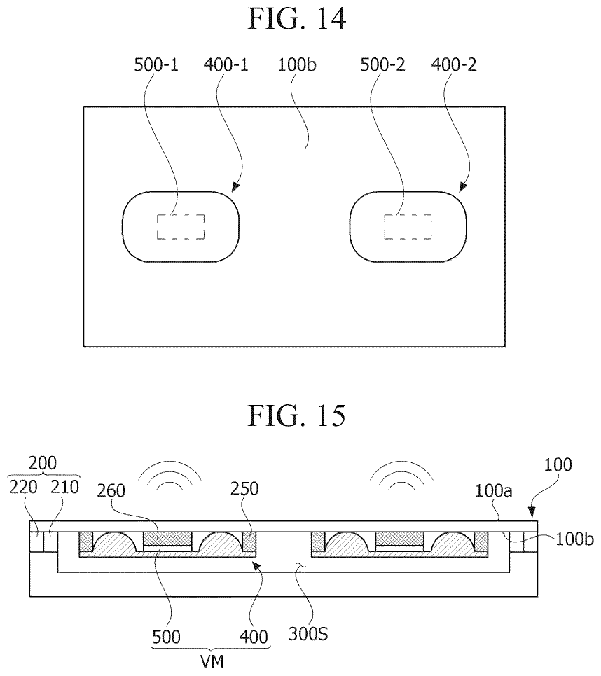

FIG. 14 is a view showing a vibration apparatus according to another implementation of the present specification. FIG. 15 is a cross-sectional view of FIG. 14. FIG. 16A is a partial enlarged view of FIG. 15. FIG. 16B is a modified example of FIG. 16A.

Referring to FIGS. 14 to 16A, the vibration plate 400 may be arranged such that the protruding part 410 faces the vibrating member 100. The protruding part may be spaced apart from the vibrating member 100. The outer side portion of the pad part 420 may be fixed to the vibrating member 100 by the third connecting member 250. In addition, the vibrating element 500 may be fixed to the vibrating member 100 by the fourth connecting member 260.

The vibrating element 500 may be fixed to the vibrating member 100 by the fourth connecting member 260. Therefore, the vibration of the vibrating element 500 may be directly transmitted to the vibrating member 100 through the fourth connecting member 260. The third connecting member 250 and the fourth connecting member 260 may include the same material, but the implementations of the present specification are not limited thereto. For example, the third connecting member 250 and the fourth connecting member 260 may include different materials.

The third connecting member 250 and the fourth connecting member 260 according to the implementation of the present specification may include an adhesive layer having excellent adhesion or adhesive force. For example, the third connecting member 250 and the fourth connecting member 260 may include a foam pad, a double-sided tape, a double-sided foam pad, a double-sided foam tape, an adhesive, a double-sided adhesive, a double-sided adhesive tape, a double-sided adhesive foam pad, or an adhesive sheet, and the implementations of the present specification are not limited thereto.

A width W1 of the fourth connecting member 260 may be the same as or different from a width W2 of the vibrating element 500. For example, the width W1 of the fourth connecting member 260 may be larger or smaller than the width W2 of the vibrating element 500. A thickness of the fourth connecting member 260 may be smaller than a thickness of the fourth connecting member 260.

According to an implementation, a vibration region 401S may be freely adjusted by adjusting an area in which the protruding part 410 is arranged outside the periphery of the vibrating element 500. According to an implementation, the rigidity of the vibrating plate 400 may be adjusted by adjusting the width and/or height of the protruding part 410. As the width and/or height of the protruding part 410 increases, the rigidity of the vibrating plate 400 may increase. As the rigidity of the vibrating plate 400 increases, the reproduction frequency band transmitted to the vibrating member 100 through the vibrating plate 400 may increase. On the contrary, as the width and/or height of the protruding part 410 decreases, the rigidity of the vibrating plate 400 may decrease. As the rigidity of the vibrating plate 400 decreases, the reproduction frequency band may be lowered.

A wiring W1 connected to the vibrating element 500 may be connected to the outside through a first extension hole 423 formed in the protruding part 410 and a second extension hole 251 of the third connecting member. However, the implementations of the present specification are not limited thereto. For example, the wiring W1 may pass through the pad part 420 to be connected to the outside. Referring to FIG. 16B, the vibration plate 400 may be arranged such that the protruding part 410 faces the vibrating member 100, and the vibrating element 500 may be arranged on the second surface 420b of the vibration plate 400. In this case, the extension hole for connecting the wiring W1 to the outside may be omitted.

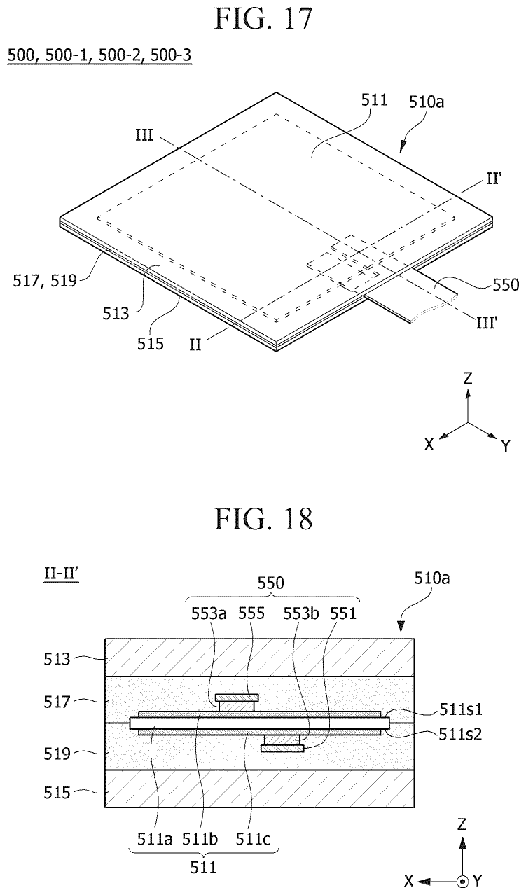

FIG. 17 is a view showing a vibrating element according to one implementation of the present specification. FIG. 18 is a cross-sectional view taken along line II-II′ shown in FIG. 17 according to one implementation of the present specification. FIG. 19 is a cross-sectional view taken along line III-III′ shown in FIG. 17 according to one implementation of the present specification. FIGS. 17 to 19 illustrate the vibrating elements described with reference to FIGS. 1 to 15.

Referring to FIGS. 17 to 19, the vibrating element 500 according to one implementation of the present specification may include a vibration generating part 510a.

The vibration generating part 510a may include a piezoelectric material having the piezoelectric property. The vibration generating part 510a may be made of a ceramic-based piezoelectric material capable of implementing relatively high vibrations or may be made of a piezoelectric ceramic having a perovskite-based crystal structure. For example, the vibration generating part 510a may be a vibration generating element, a vibration film, a vibration generating film, a vibrator, a vibration generator, an active vibrator, an active vibration generator, an actuator, an exciter, a film actuator, a film exciter, an ultrasonic actuator, or an active vibrating member, and the implementations of the present specification are not limited thereto.

The vibration generating part 510a according to one implementation of the present specification may include a vibrating part 511.

The vibrating part 511 may be configured to vibrate by the piezoelectric effect according to a driving signal. The vibrating part 511 may include at least one of a piezoelectric inorganic material and a piezoelectric organic material. For example, the vibrating part 511 may be a vibrating element, a piezoelectric element, a piezoelectric element part, a piezoelectric element layer, a piezoelectric structure, a piezoelectric vibrating part, or a piezoelectric vibration layer, and the implementations of the present specification are not limited thereto.

The vibrating part 511 according to one implementation of the present specification may include a vibration layer 511a, a first electrode layer 511b, and a second electrode layer 511c.

The vibration layer 511a may include a piezoelectric material or an electro-active material having a piezoelectric effect. For example, piezoelectric materials may have the properties that the pressure or torsion acts on the crystal structure by an external force, potential differences are generated by dielectric polarization due to changes in the relative positions of positive (+) and negative (−) ions, and conversely vibrations are generated by electric fields due to an applied voltage. For example, the vibration layer 511a may be a piezoelectric layer, a piezoelectric material layer, an electrically active layer, a piezoelectric composite layer, a piezoelectric composite, a piezoelectric ceramic composite, or the like and the implementations of the present specification are not limited thereto.

The vibration layer 511a may be made of a ceramic-based material capable of implementing relatively high vibrations or a piezoelectric ceramic having a perovskite-based crystal structure. The perovskite crystal structure has piezoelectric and/or inverse-piezoelectric effects and may be a plate-shaped structure with orientation.

The piezoelectric ceramic may be composed of a single crystal ceramic having a single crystal structure or a ceramic material having a polycrystalline structure, or a polycrystalline ceramic. The piezoelectric material of single crystal ceramic may include α-AlPO₄, α-SiO₂, LiNbO₃, Tb₂(MoO₄)₃, Li₂B₄O₇, or ZnO, but the implementations of the present specification are not limited thereto. The piezoelectric material of the polycrystalline ceramic may include a lead zirconate titanate (PZT)-based material including lead (Pb), zirconium (Zr), and titanium (Ti), or a lead zirconate nickel niobate (PZNN) material including lead (Pb), zirconium (Zr), nickel (Ni), and niobium (Nb), but the implementations of the present specification are not limited thereto. For example, the vibration layer 511a may include at least one of CaTiO₃, BaTiO₃, and SrTiO₃ that does not contain lead (Pb), but the implementations of the present specification are not limited thereto.

The first electrode layer 511b may be arranged on a first surface (or an upper surface or a front surface) 511s1 of the vibration layer 511a. The first electrode layer 511b may have the same size as the vibration layer 511a or may have a smaller size than the vibration layer 511a.

The second electrode layer 511c may be arranged on a second surface (or a lower surface or a rear surface) 511s2 that is different from or opposite to the first surface 511s1 of the vibration layer 511a. The second electrode layer 511c may have the same size as the vibration layer 511a or a smaller size than the vibration layer 511a. For example, the second electrode layer 511c may have the same shape as the vibration layer 511a, but the implementations of the present specification are not limited thereto.

According to one implementation of the present specification, in order to prevent an electrical connection (or short circuit) between the first electrode layer 511b and the second electrode layer 511c, each of the first electrode layer 511b and the second electrode layer 511c may be formed on the remaining portions except for an edge portion of the vibration layer 511a. For example, the first electrode layer 511b may be formed on the entire remaining portion except for an edge portion of the first surface 511s1 of the vibration layer 511a. For example, the second electrode layer 511c may be formed on the entire remaining portion except for an edge portion of the second surface 511s2 of the vibration layer 511a. For example, the distance between the side surface (or outer side wall) of each of the first electrode layer 511b and the second electrode layer 511c and the side surface (or outer side wall) of the vibration layer 511a may be at least 0.5 mm. For example, the distance between the side surface of each of the first electrode layer 511b and the second electrode layer 511c and the side surface of the vibration layer 511a may be at least 1 mm, but the implementations of the present specification are not limited thereto.

At least one of the first electrode layer 511b and the second electrode layer 511c according to one implementation of the present specification may be made of a transparent conductive material, a semitransparent conductive material, or an opaque conductive material. For example, the transparent or semitransparent conductive material may include indium tin oxide (ITO) or indium zinc oxide (IZO), but implementations of the present specification are not limited thereto. The opaque conductive material may include gold (Au), silver (Ag), platinum (Pt), palladium (Pd), molybdenum (Mo), magnesium (Mg), carbon or silver (Ag) containing glass frit, or the like, or an alloy thereof, but the implementations of the present specification are not limited thereto. For example, each of the first electrode layer 511b and the second electrode layer 511c may include silver (Ag) having a low resistivity to improve the electrical properties and/or vibration properties of the vibration layer 511a. For example, the carbon may be a carbon material including carbon black, ketjen black, carbon nano tubes, and graphite, but the implementations of the present specification are not limited thereto.

The vibration layer 511a may be polarized (or poled) by a constant voltage applied to the first electrode layer 511b and the second electrode layer 511c in a constant temperature atmosphere or a temperature atmosphere changed from high temperature to room temperature, but the implementations of the present specification are not limited thereto. For example, a polarization direction (or a poling direction) formed in the vibration layer 511a may be formed or oriented (or arranged) from the first electrode layer 511b to the second electrode layer 511c, but is not limited thereto, and may be formed or oriented (or arranged) from the second electrode layer 511c to the first electrode layer 511b.

The vibration layer 511a may vibrate by alternately repeating contraction and/or expansion by a reverse piezoelectric effect in accordance with a driving signal applied to the first electrode layer 511b and the second electrode layer 511c from the outside. For example, the vibration layer 511a may vibrate in a vertical direction (or thickness direction) and a planar direction by signals applied to the first electrode layer 511b and the second electrode layer 511c. The vibration layer 511a may improve the vibration properties, including the acoustic properties and/or the sound pressure properties of the vibration generating part 510a by displaced (or vibrated or driven) by contraction and/or expansion in the planar direction.

The vibration generating part 510a according to one implementation of the present specification may further include a first cover member 513 and a second cover member 515.

The first cover member 513 may be arranged on a first surface of the vibrating part 511. For example, the first cover member 513 may be configured to cover the first electrode layer 511b of the vibrating part 511. For example, the first cover member 513 may be configured to have a larger size than the vibrating part 511. The first cover member 513 may be configured to protect the first surface of the vibrating part 511 and the first electrode layer 511b.

The second cover member 515 may be arranged on the second surface of the vibrating part 511. For example, the second cover member 515 may be configured to cover the second electrode layer 511c of the vibrating part 511. For example, the second cover member 515 may be configured to have a larger size than the vibrating part 511 and may be configured to have the same size as the first cover member 513. The second cover member 515 may be configured to protect the second surface of the vibrating part 511 and the second electrode layer 511c.

The first cover member 513 and the second cover member 515 according to one implementation of the present specification may include the same or different materials. For example, each of the first cover member 513 and the second cover member 515 may be a polyimide film or a polyethylene terephthalate film, but the implementations of the present specification are not limited thereto.

The first cover member 513 may be connected or coupled to the first surface of the vibrating part 511 or the first electrode layer 511b via the first adhesive layer 517. For example, the first cover member 513 may be connected or bonded to the first surface of the vibrating part 511 or the first electrode layer 511b by a film laminating process using the first adhesive layer 517 as a medium.

The second cover member 513 may be connected or coupled to the second surface of the vibrating part 511 or the second electrode layer 511c via the second adhesive layer 519. For example, the second cover member 513 may be connected or coupled to the second surface of the vibrating part 511 or the second electrode layer 511c by a film laminating process using the second adhesive layer 519 as a medium.

Each of the first adhesive layer 517 and the second adhesive layer 519 according to the implementation of the present specification may include an electrical insulating material capable of compression and restoration while having adhesive properties. For example, each of the first adhesive layer 517 and the second adhesive layer 519 may include an epoxy resin, an acrylic resin, a silicone resin, or a urethane resin, but the implementations of the present specification are not limited thereto.

The first adhesive layer 517 and the second adhesive layer 519 may be configured between the first cover member 513 and the second cover member 515 to surround the vibrating part 511. For example, at least one of the first adhesive layer 517 and the second adhesive layer 519 may be configured to surround the vibrating part 511.

The vibrating element 500, a plurality of vibration generating devices 500-1, 500-2, and 500-3), or a vibration generating part 510a according to one implementation of the present specification may further include a signal supply member 550.

The signal supply member 550 may be configured to supply a driving signal supplied from a driving circuit to the vibrating part 511. The signal supply member 550 may be configured to be electrically connected to the vibrating part 511. The signal supply member 550 may be configured to be electrically connected to the first electrode layer 511b and the second electrode layer 511c of the vibrating part 511.

A portion of the signal supply member 550 may be accommodated (or inserted) between the first cover member 513 and the second cover member 515. The end portion (or terminal portion or one side) of the signal supply member 550 may be arranged or inserted (or accommodated) in a portion between one side edge portion of the first cover member 513 and one side edge portion of the second cover member 515. The one side edge portion of the first cover member 513 and one side edge portion of the second cover member 515 may accommodate or vertically cover the end portion (or terminal portion or one side) of the signal supply member 550. Accordingly, the signal supply member 550 may be integrated with the vibration generating part 510a. For example, the signal supply member 550 may be configured from a signal cable, a flexible cable, a flexible printed circuit cable, a flexible flat cable, a single-sided flexible printed circuit, a single-sided flexible printed circuit board, a flexible multi-layer printed circuit, or a flexible multi-layer printed circuit board, but the implementations of the present specification are not limited thereto.

The signal supply member 550 according to one implementation of the present specification may include a base member 551 and a plurality of signal lines 553a and 553b. For example, the signal supply member 550 may include a base member 551, a first signal line 553a, and a second signal line 553b.

The base member 551 may include a transparent or opaque plastic material, but the implementations of the present specification are not limited thereto. The base member 551 has a constant width along the first direction X and may be elongated along the second direction Y intersecting the first direction X.

The first and second signal lines 553a and 553b are arranged on the first surface of the base member 551 to be parallel to the second direction Y, and may be spaced apart from each other or electrically separated from each other along the first direction X. The first and second signal lines 553a and 553b may be arranged parallel to each other on the first surface of the base member 551. For example, the first and second signal lines 553a and 553b may be implemented in a line shape by patterning a metal layer (or a conductive layer) formed or deposited on the first surface of the base member 551.

End portions (or terminal potions or one side) of the first and second signal lines 553a and 553b may be individually bent or curved by being separated from each other.

The end portion (or terminal portion or one side) of the first signal line 553a may be electrically connected to the first electrode layer 511b of the vibrating part 511. For example, the end portion of the first signal line 553a may be electrically connected to at least a portion of the first electrode layer 511b of the vibrating part 511 at one edge portion of the first cover member 513. For example, the end portion (or terminal portion or one side) of the first signal line 553a may be electrically directly connected to at least a portion of the first electrode layer 511b of the vibrating part 511. For example, the end portion (or terminal portion or one side) of the first signal line 553a may be directly connected to or in direct contact with the first electrode layer 511b of the vibrating part 511. For example, the end portion of the first signal line 553a may be electrically connected to the first electrode layer 511b via a conductive double-sided tape. Accordingly, the first signal line 553a may supply the first driving signal supplied from the vibration driving part to the first electrode layer 511b of the vibrating part 511.

The end portion (or terminal portion or one side) of the second signal line 553b may be electrically connected to the second electrode layer 511c of the vibrating part 511. For example, the end portion of the second signal line 553b may be electrically connected to at least a portion of the second electrode layer 511c of the vibrating part 511 at one edge portion of the second cover member 515. For example, the end portion of the second signal line 553b may be electrically directly connected to at least a portion of the second electrode layer 511c of the vibrating part 511. For example, the end portion of the second signal line 553b may be directly connected to or in direct contact with the second electrode layer 511c of the vibrating part 511. For example, the end portion of the second signal line 553b may be electrically connected to the second electrode layer 511c via a conductive double-sided tape. Accordingly, the second signal line 553b may supply a second driving signal supplied from the vibration driving part to the second electrode layer 511c of the vibrating part 511.

The signal supply member 550 according to one implementation of the present specification may further include an insulating layer 555.

The insulating layer 555 may be arranged on the first surface of the base member 551 to cover each of the first signal line 553a and the second signal line 553b except for an end portion (or one side) of the signal supply member 550.

The end portion (or one side) of the signal supply member 550 including an end portion (or one side) of the base member 551 and an end portion (or one side) 555a of the insulating layer 555 may be inserted (or accommodated) between the first cover member 513 and the second cover member 515, and may be fixed between the first cover member 513 and the second cover member 515 by the first adhesive layer 517 and the second adhesive layer 519. Accordingly, the end portion (or one side) of the first signal line 553a may be maintained in an electrically connected state to the first electrode layer 511b of the vibrating part 511, and the end portion (or one side) of the second signal line 553b may be maintained in an electrically connected state to the second electrode layer 511c of the vibrating part 511. In addition, since the end portion (or one side) of the signal supply member 550 is inserted (or accommodated) and fixed between the vibrating part 511 and the first cover member 513, a poor connection between the vibration generating part 510a and the signal supply member 550 due to the movement of the signal supply member 550 may be prevented.

In the signal supply member 550 according to one implementation of the present specification, each of the end portion (or one side) of the base member 551 and an end portion (or one side) 555a of the insulating layer 555 may be removed. For example, each of the end portion of the first signal line 553a and the end portion of the second signal line 553b may be exposed to the outside without being supported or covered by the end portion (or one side) of the base member 551 and the end portion (or one side) 555a of the insulating layer 555. For example, the end portions of each of the first and second signal lines 553a and 553b may protrude (or extend) to have a certain length from an end 551e of the base member 551 or an end 555e of the insulating layer 555. Accordingly, each end portion (or terminal portion or one side) of each of the first and second signal lines (553a and 553b) may be bent individually or independently.

The end portion (or one side) of the first signal line 553a that is not supported by each of the end portion (or one side) of the base member 551 and the end portion (or one side) 555a of the insulating layer 555 may be directly connected to or in direct contact with the first electrode layer 511b of the vibrating part 511. The end portion (or one side) of the second signal line 553b that is not supported by each of the end portion (or one side) of the base member 551 and the end portion (or one side) 555a of the insulating layer 555 may be directly connected to or in direct contact with the second electrode layer 511c of the vibrating part 511.

According to one implementation of the present specification, a portion of the signal supply member 550 or a portion of the base member 551 may be arranged or inserted (or accommodated) between the first cover member 513 and the second cover member 515 such that the signal supply member 550 is integral with the vibration generating part 510a. Accordingly, the vibration generating part 510a and the signal supply member 550 may be configured as a single component, thereby achieving the effect of a uni-materialization.

According to one implementation of the present specification, since the first signal line 553a) and the second signal line 553b of the signal supply member 550 are integrated with the vibration generating part 510a, a soldering process for electrical connection between the vibration generating part 510a and the signal supply member 550 is not required, and thus, the structure and manufacturing process of the vibrating element 500 or the plurality of vibration generating devices (500-1, 500-2, and 500-3 may be simplified, thereby resulting in an effect of improving harmful processes.

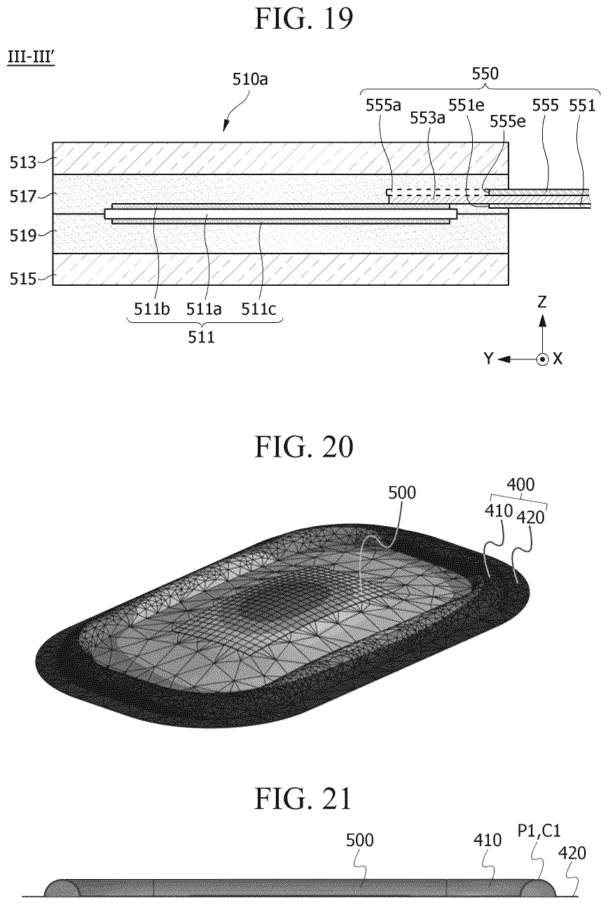

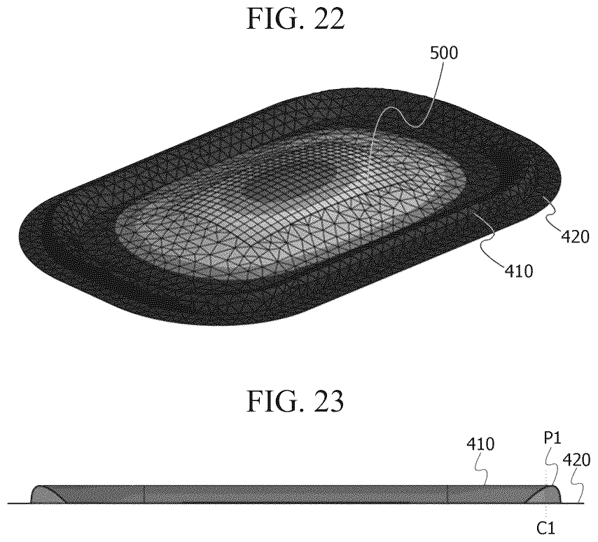

FIG. 20 is a view showing a vibration module according to one implementation of the present specification. FIG. 21 is a cross-sectional view of FIG. 20. FIG. 22 is a view showing a vibration module according to another implementation of the present specification. FIG. 23 is a cross-sectional view of FIG. 22.

FIG. 20 shows the results of measuring a first resonance frequency of a vibration module according to one implementation of the present specification. FIG. 21 shows the results of measuring a first resonance frequency of a vibration module according to another implementation of the present specification.

Referring to FIGS. 20 and 21, the vibration module is designed such that the curved point P1 of the protruding part 410 is located at the center C1 of the protruding part, and referring to FIGS. 22 and 23, the vibration module of another implementation is designed such that the curved point P1 of the protruding part 410 is located on the outer side of the center C1 of the protruding part. Therefore, the vibration region of the structure of FIG. 21 may be larger than that of the structure of FIG. 20. The protruding parts were manufactured identically from PET, and the vibrating element 500 was manufactured in the same size.

As a result of the measurement, the vibration of FIG. 20 was measured to have a primary resonance frequency of 127 Hz, whereas the primary resonance frequency of FIG. 21 was measured to be 77 Hz. Accordingly, it may be seen that the reproduction frequency band may be lowered as the vibration region is increased. In addition, it may be seen that the reproduction frequency band may be adjusted by controlling the vibration region by adjusting the curved point of the protruding part.

The vibration apparatus according to one or more implementations of the present specification may be described as follows.

A vibration apparatus according to one or more implementations of the present specification may include a vibrating member, and a vibration module including a vibration plate arranged on the vibrating member, and a vibrating element arranged on the vibration plate, wherein the vibration plate includes a protruding part arranged outside the periphery of the vibrating element.

According to one or more implementations of the present specification, the vibrating plate may include the vibration plate includes a vibration region arranged on the inner side of the protruding part and an outer side portion arranged on the outer side of the protruding part and an area of the vibration region is wider than that of the outer side portion.

According to one or more implementations of the present specification, the vibrating plate may include a pad part on which the vibrating element is arranged, and the protruding part may be arranged on the pad part.

According to one or more implementations of the present specification, the pad part and the protruding part may include the same material.

According to one or more implementations of the present specification, the pad part and the protruding part may include different materials, and the protruding part may include a fastening part coupled to the pad part.

According to one or more implementations of the present specification, the height of the protruding part may be greater than that of the vibrating element.

According to one or more implementations of the present specification, the pad part may include a first surface on which the vibrating element and the protruding part are arranged and a second surface that is an opposite surface of the first surface.

According to one or more implementations of the present specification, the vibrating plate may be attached to the vibrating member by the second surface of the pad part.

According to one or more implementations of the present specification, the vibrating plate may be attached to the vibrating member by the first surface of the pad part.

According to one or more implementations of the present specification, the first surface of the vibrating plate may be attached to the vibrating member by a third connecting member, and the vibrating element may be attached to the vibrating member by a fourth connecting member.

According to one or more implementations of the present specification, a peak of the protruding part may be arranged on an outer side with respect to the center of the width of the protruding part.

According to one or more implementations of the present specification, the peak of the protruding part may be arranged on an inner side with respect to the center of the width of the protruding part.

According to one or more implementations of the present specification, the protruding part may include a first protrusion line facing a first side surface of the vibrating element, a second protrusion line facing a second side surface of the vibrating element, a third protrusion line facing a third side surface of the vibrating element, a fourth protrusion line facing a fourth side surface of the vibrating element, a first connecting line connecting the first protrusion line and the fourth protrusion line, a second connecting line connecting the first protrusion line and the second protrusion line, a third connecting line connecting the second protrusion line and the third protrusion line, and a fourth connecting line connecting the third protrusion line and the fourth protrusion line, and the first connecting line to the fourth connecting line may have a curvature.

According to one or more implementations of the present specification, the protruding part may include a plurality of grooves.

According to one or more implementations of the present specification, the plurality of grooves may be located on the first connecting line to the fourth connecting line.

According to one or more implementations of the present specification, the vibrating element may include a first vibrating element arranged on the first surface of the pad part and a second vibrating element arranged on a second surface facing the first surface of the pad part.

According to one or more implementations of the present specification, the pad part may include an insertion groove into which a second vibrating element is inserted, and the first vibrating element may be arranged on the insertion groove.

According to one or more implementations of the present specification, the vibration apparatus may include a support member that is coupled with the vibrating member to accommodate the vibration module, and a coupling member bonding the vibrating member to the support member.

According to one or more implementations of the present specification, the protruding part may be arranged to face a support member, and the protruding part may be arranged to be spaced apart from the support member.

According to one or more implementations of the present specification, the protruding part may be arranged to face the vibrating member, and the protruding part may be arranged to be spaced apart from the vibrating member.

What is claimed is:

1. A vibration apparatus comprising:
a vibrating member; and
a vibration module including a vibration plate arranged on the vibrating member, and a vibrating element arranged on the vibration plate,
wherein the vibrating member is configured to vibrate in response to vibrations applied by the vibrating element of the vibration module, and
wherein the vibration plate includes a protruding part arranged outside a periphery of the vibrating element.

2. The vibration apparatus of claim 1, wherein the vibration plate includes:
a vibration region located on an inner side of the protruding part; and
an outer side portion located on an outer side of the protruding part,
wherein an area of the vibration region is wider than that of the outer side portion.

3. The vibration apparatus of claim 1, wherein the vibration plate includes a pad part on which the vibrating element is arranged, and
wherein the protruding part is arranged on the pad part.

4. The vibration apparatus of claim 3, wherein the pad part and the protruding part include the same material.

5. The vibration apparatus of claim 3, wherein the pad part and the protruding part include different materials, and
wherein the protruding part is fastened and coupled to the pad part.

6. The vibration apparatus of claim 1, wherein the protruding part has a height which is greater than that of the vibrating element.

7. The vibration apparatus of claim 3, wherein the pad part includes a first surface on which the vibrating element and the protruding part are arranged and a second surface that is opposite to the first surface.

8. The vibration apparatus of claim 7, wherein the vibration plate is attached to the vibrating member through the second surface of the pad part.

9. The vibration apparatus of claim 7, wherein the vibration plate is attached to the vibrating member through the first surface of the pad part.

10. The vibration apparatus of claim 9, wherein the first surface of the pad part is attached to the vibrating member through a third connecting member, and
wherein the vibrating element is attached to the vibrating member through a fourth connecting member.

11. The vibration apparatus of claim 1, wherein the highest protruding peak point of the protruding part is located on an outer side with respect to the center of the width of the protruding part.

12. The vibration apparatus of claim 1, wherein the highest protruding peak point of the protruding part is located inwardly with respect to the center of the width of the protruding part.

13. The vibration apparatus of claim 1, wherein the protruding part includes:
a first protrusion line facing a first side surface of the vibrating element,
a second protrusion line facing a second side of the vibrating element,
a third protrusion line facing a third side surface of the vibrating element,
a fourth protrusion line facing a fourth side surface of the vibrating element,
a first connecting line connecting the first protrusion line and the fourth protrusion line,
a second connecting line connecting the first protrusion line and the second protrusion line,
a third connecting line connecting the second protrusion line and the third protrusion line, and
a fourth connecting line connecting the third protrusion line and the fourth protrusion line,
wherein the first to fourth connecting lines have a curvature.

14. The vibration apparatus of claim 13, wherein the protruding part includes a plurality of grooves, and
wherein the plurality of grooves are located on the first connecting line to the fourth connecting line.

15. The vibration apparatus of claim 3, wherein the vibrating element includes:
a first vibrating element arranged on a first surface of the pad part; and
a second vibrating element arranged on a second surface of the pad part opposite to the first surface.

16. The vibration apparatus of claim 15, wherein the second surface of the pad part includes an insertion part into which the second vibrating element is inserted, and
wherein the first vibrating element is arranged on the first surface of the pad part at a location corresponding to a location of the insertion part on the second surface.

17. The vibration apparatus of claim 1, further comprising
a support member coupled with the vibrating member to accommodate the vibration module, and
a coupling member bonding the vibrating member to the support member.

18. The vibration apparatus of claim 17, wherein the protruding part is arranged to face the support member, and
the protruding part is arranged to be spaced apart from the support member.

19. The vibration apparatus of claim 17, wherein the protruding part is arranged to face the vibrating member, and
the protruding part is arranged to be spaced apart from the vibrating member.

20. A vibration apparatus comprising:
a vibration module comprising a vibrating element arranged on a vibration plate; and
a vibrating member attached to the vibration plate of the vibration module and configured to vibrate in response to vibrations applied by the vibrating element of the vibration module,
wherein a thickness of a first portion of the vibration plate where the vibrating element is arranged is smaller than a thickness of a second portion of the vibration plate that surrounds the vibrating element.
